(19) United States
(12) Patent Application Publication
(10) Pub. No.: US 2008/0002956 A1
(43) Pub. Date: Jan. 3, 2008

(54) Portrait Photography Apparatus

(75) Inventor: Takeyoshi Iguchi, Tokyo (JP)

Correspondence Address: SQUIRE, SANDERS & DEMPSEY L.L.P., 1 MARITIME PLAZA, SUITE 300, SAN FRANCISCO, CA, 94111, US

(73) Assignee: KONICA MINOLTA HOLDINGS, INC., TOKYO (JP)

(21) Appl. No.: 11/794,875

(22) PCT Filed: Nov. 25, 2005
(86) PCT No.: PCT/JP05/21679

§ 371 Date: Jul. 5, 2007

(30) Foreign Application Priority Data
Jan. 11, 2005 (JP) 2005-003562

(51) Int. Cl. G03B 15/00

(52) U.S. Cl. 396/2

(57) ABSTRACT

A portrait photography apparatus in which a camera and illumination means are sustained at optimal height and width when the apparatus is used, whereas the camera and the illumination means are covered with an enclosure when the apparatus is not used, dustproof and crime prevention effect is attained by lowering the apparatus, and mobility is enhanced by a handle provided on the enclosure and legs with rollers sustained in parallel. The portrait photography apparatus is characterized by including: an accommodating section that accommodates a camera and an illumination section, and includes an outer covering, which can be opened and closed, and which is disposed at an upper surface section or a side surface section; a supporting section, disposed below the accommodating section, to support the accommodating section; a height adjusting section, which is expandable and contractable, to connect the accommodating section to the supporting section; and a plurality of leg members, each of which has a caster roller.

### FIELD OF THE INVENTION

The present invention relates to a portrait photography apparatus having a mobile function.

### TECHNICAL BACKGROUND

There has been well known a proof picture photographing apparatus for automatically photographing a personal face picture to be attached to various official documents, such as an application of passport, a resume, examination applications of various kinds of examinations, etc., (for instance, refer to Patent Document 1). Further, in a sightseeing spot in which observation views and other landscapes are sales points for the tourists visiting therein, a souvenir picture photographing apparatus, which creates a unique souvenir picture by synthesizing a visitor's picture, currently photographed by the apparatus, with an image of the landscape provided in advance, would be installed (for instance, refer to Patent Document 2).

Conventionally, such the portrait photography apparatus is usually equipped in a self-service box or a space partitioned by partition members shaped in a curtain or the like, so that a customer entering in the site can acquire an objective photograph by operating an operation display device, mounted on the portrait photography apparatus and called a touch panel, according to guiding screens displayed on the touch panel.

The abovementioned portrait photography apparatus cannot be easily moved, since the apparatus is manufactured on the premise that the apparatus should be fixed at a predetermined installation place. Accordingly, when the portrait photography apparatus is unavailable in the unmanned state at the predetermined installation place, the crime prevention and the dust proof effects should be considered as its indispensable conditions.

Some of the souvenir pictures each of which includes a portrait as a central subject, are taken as a visit memorial photography only in such an event that is held for a limited opening period. Unfortunately, it is apparent that the conventional fixed-type portrait photography apparatus mentioned in the above is inconvenient as the apparatus to be employed for the abovementioned purpose.

Further, even when the portrait photography apparatus is usually used at a fixed place, there would arise another demand that the apparatus should be installed in another place only within a predetermined time period of the daytime. Unfortunately, it is also apparent that it is quite difficult for the conventional fixed-type portrait photography apparatus mentioned in the above to cope with such the demand.

In the situations mentioned in the above, to conduct image capturing operations so as to obtain good finished pictures, it has been generally practiced that various kinds of photographing conditions, including lighting conditions suitable for the photographing place, are established in advance, and then, a professional photographer employs an exclusive camera to capture images under such the conditions established in advance.

However, to hire the professional photographer would result in an increase of the personnel expenses. Accordingly, there has been a fear that it would also result in a cost increase of the photography concerned.

[Patent Document 1]

Tokkai 2002-214690 (first page), (Japanese Non-Examined Patent Publication)

[Patent Document 2]

Tokkaihei 5-161064 (first page), (Japanese Non-Examined Patent Publication)

### DISCLOSURE OF THE INVENTION

Subject to be Solved by the Invention

The present invention is achieved in view of the abovementioned state. The object of the present invention is to provide a portrait photography apparatus, in which a camera and illumination means are sustained at optimal height and width when the apparatus is used, whereas the camera and the illumination means are covered with an enclosure when the apparatus is not used, dustproof and crime prevention effect is attained by lowering the apparatus, and mobility is enhanced by a handle provided on the enclosure and legs with rollers sustained in parallel.

Means for Solving the Subject

The abovementioned subject can be attained by realizing the following items.
1. A portrait photography apparatus, characterized by comprising: an accommodating section that accommodates a camera and an illumination section, and includes an outer covering, which can be opened and closed, and which is disposed at an upper surface section or a side surface section; a supporting section, disposed below the accommodating section, to support the accommodating section; a height adjusting section, which is expandable and contractable, to connect the accommodating section to the supporting section; and a plurality of leg members, each of which has a caster roller.
2. The portrait photography apparatus, recited in claim 1, characterized by further comprising: a control section to control the height adjusting section so that a height of the accommodating section during a non-operating time is lower than that during an operating time.
3. The portrait photography apparatus, recited in claim 1 or claim 2, characterized in that the accommodating section is provided with a carrying handle.
4. The portrait photography apparatus, recited in any one of claims 1-3, characterized in that each of the plurality of leg members is movable inward and outward in respect to an outer circumferential surface of the supporting section, and at least two of the plurality of leg members can be maintained outward in parallel to each other, while another one of the plurality of leg members or other ones of the plurality of leg members can be maintained inward.

### EFFECT OF THE INVENTION

According to the invention described in item 1, by expanding the height adjusting section, the camera and the illumination section can be sustained at a desirable height, while, by contracting the height adjusting section, the height of the camera and the illumination section can be lowered so as to secure the stability of the apparatus. Accordingly, in addition to the above, by closing the outer enclosure, it becomes possible to provide a mobile portrait photography apparatus, which has the effects, such as dustproof and crime prevention effects, breakage prevention effect of the camera and the illumination unit when conveying the apparatus.

According to the invention described in item 2, since the photographer can maintain the camera and the illumination unit at a desirable height position by adjusting the height adjusting section when using the portrait photography apparatus, while the photographer can set the camera and the illumination unit at the lowest height position by adjusting the height adjusting section when not using the portrait photography apparatus, it becomes possible to provide such a portrait photography apparatus that makes it possible not only to conduct an image capturing operation to obtain a high quality image, but also to conduct an easy moving operation for changing its installation place.

According to the invention described in item 3, it becomes possible to provide a portrait photography apparatus that is provided with a useful member for moving the apparatus.

According to the invention described in item 4, it becomes possible to provide a portrait photography apparatus that can be easily moved and has a high stability when installed.

### BRIEF DESCRIPTION OF THE DRAWINGS

FIG. 1(a), FIG. 1(b) and FIG. 1(c) show conceptual schematic diagrams indicating a configuration of a portrait photography apparatus.

FIG. 2 shows a block diagram indicating a controlling relationship between blocks included in a portrait photography apparatus.

FIG. 3(a), FIG. 3(b) and FIG. 3(c) show conceptual schematic diagrams indicating a mechanism of a height adjusting section.

FIG. 4 shows a front view of an outer appearance of a portrait photography apparatus when a photographing operation is activated.

FIG. 5 shows a front view of an outer appearance of a portrait photography apparatus when a photographing operation is deactivated.

FIG. 6(a) and FIG. 6(b) show conceptual schematic diagrams indicating a configuration of a supporting section 20.

### EXPLANATION OF NOTATIONS

10 an accommodating section
11 a top plate
13 a camera
14 a printer
16 an operation display screen
17 a remote controller
18 a printed circuit board
19 an outer enclosure
20 a supporting section
21-24 leg members
30 a height adjusting section
31 a connecting member
34 an elevation male screw
36 an elevation motor
50 a carrying handle
C a control section
ST1-ST4 strobe light sources

### BEST MODE FOR IMPLEMENTING THE INVENTION

Referring to the drawings, the embodiment of the present invention will be detailed in the following.

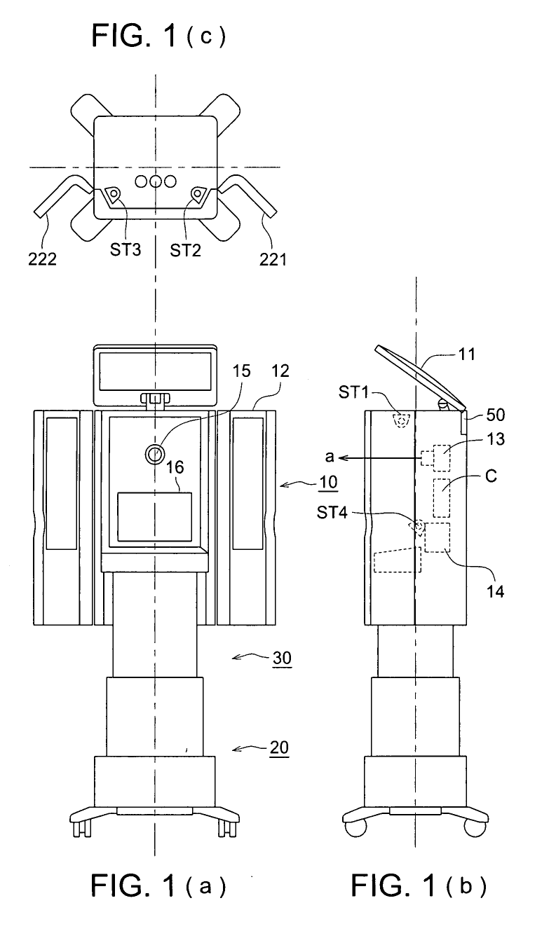

FIG. 1(a), FIG. 1(b) and FIG. 1(c) show conceptual schematic diagrams indicating a configuration of the portrait photography apparatus, and are a front view, a side view and a top view, respectively.

The portrait photography apparatus shown in the abovementioned Figures is constituted by an accommodating section 10, a supporting section 20 and a height adjusting section 30.

The accommodating section 10 is provided with a top plate 11 that opens upward and closes downward, and doors 12 that opens and closes in left and right directions. Further, a camera 13, a printer 14, a control section C, strobe light sources ST1-ST4, etc., are accommodated in the accommodating section 10.

The camera 13 is a digital camera to capture an image of the subject residing at a certain position in the direction indicated by the arrow “a”, and then, to transmit image information acquired by the image capturing operation to the control section C. The printer 14 outputs a hardcopy of the image of the subject based on the digital image data sent from the control section C. In this connection, a printer employing any one of various kinds of technical methods, such as a thermal sublimation method, an ink-jet printing method, an electron-photographic method, etc., can be employed as the printer 14 as needed.

When the doors 12 of the accommodating section 10 are opened in both left and right directions, strobe reflection surfaces 221, 222 attached to rear sides of the doors 12 emerge, while a lens 15 of the camera 13 and an operation display screen 16 emerge in front of the accommodating section 10. The operation display screen 16 is a touch panel widely used for general purpose, which is provided with both a displaying function and an inputting function. In this connection, the inner surface of the top plate 11 is also finished as a reflection surface so as to guide the strobe light forward when the top plate 11 is opened.

Massive and heavy parts, such as an electric power supplying section, a motor, etc., are accommodated into the inner space of the supporting section 20, to a bottom section of which leg members, each having caster roller, are attached.

The height adjusting section 30 serves as a member for supporting the accommodating section 10 in the upward direction relative to the supporting section 20. Further, it is possible to elevate or lower the height of the accommodating section 10 so as to stop it at a position of an arbitral (or desired) height.

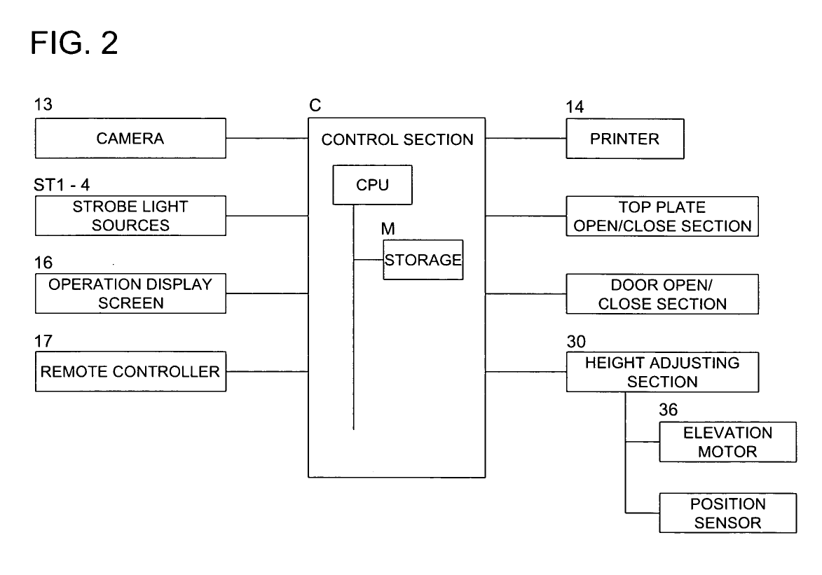

FIG. 2 shows a block diagram indicating a controlling relationship between the blocks included in the portrait photography apparatus. Incidentally, blocks unnecessary for the explanation of the present invention are omitted from the block diagram shown in FIG. 2.

The control section C is a computer system constituted by a CPU (Central Processing Unit), a storage M, an image processing IC (Integrated Circuit), an input/output port, a communication interface and a driving circuit. The control section C executes predetermined programs stored in advance in the storage M so as to conduct various kinds of controlling operations.

Various kinds of image processing, including compression processing, are applied to the image information transmitted from the camera 13 to the control section C, so as to store the compressed digital image data into a predetermined file provided in the storage M. Successively, the digital image data stored in the storage M are further processed, so as to generate the output image data, based on the instruction information inputted from the touch panel serving as the operation display screen 16, such as a size information, information of a number of paper sheets, etc. Then, the generated output image data are transmitted to the printer 14.

The user can input the instruction information into the control section C from the operation display screen 16, otherwise by employing a remote controller 17.

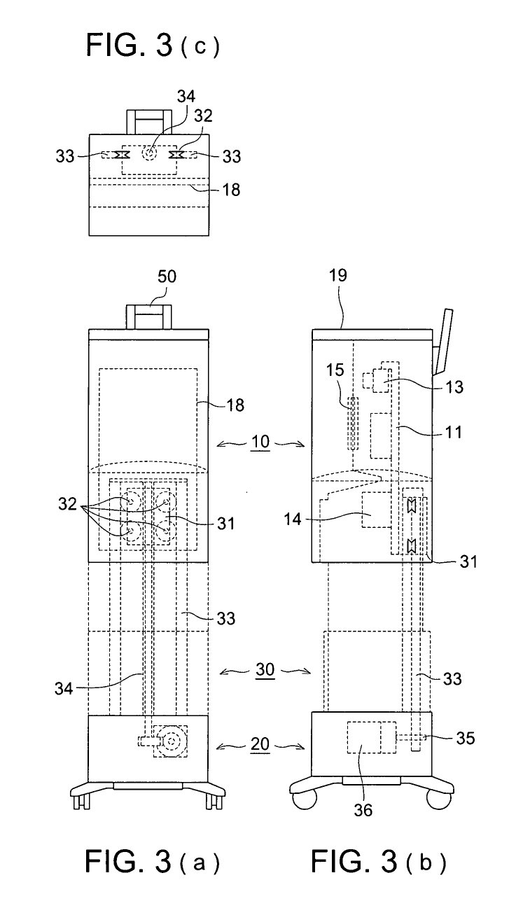

FIG. 3(a), FIG. 3(b) and FIG. 3(c) show conceptual schematic diagrams indicating a mechanism of the height adjusting section 30 for elevating and lowering the accommodating section 10.

As shown in FIGS. 3(a)-3(c), an outer enclosure 19, the camera 13, the control section C, the printer 14, etc., are mounted on a printed circuit board 18 accommodated in the accommodating section 10. Further, the printed circuit board 18 is mechanically connected to the height adjusting section 30 through a connecting member 31. Four V-shaped rollers 32 are mounted on four end portions of the connecting member 31, respectively, so as to make the connecting member 31 movable along two guide members 33. A female screw is formed at a center portion of the connecting member 31, so that the connecting member 31 is moved in up and down directions by rotating an elevation male screw 34. The elevation male screw 34 is rotated by a rotating action of a worm wheel 35 driven by an elevation motor 36. Position sensors (not shown in the drawings) are disposed at an allowable highest position and an allowable lowest position of the connecting member 31, respectively, so that the control section C controls the elevation motor 36 based on the signals outputted by the position sensors, to prevent the connecting member 31 from going over the moving limits, namely, the allowable highest position and the allowable lowest position.

The accommodating section 10 is elevated or lowered by the height adjusting section 30 described in the foregoing, while the photographer inputs moving information and/or stopping information from the operation display screen 16, or by employing the remote controller 17. Then, the control section C controls the elevation motor 36 of the height adjusting section 30 based on the moving information and/or the stopping information, so as to move the accommodating section 10 to a predetermined height and to stop it at the position.

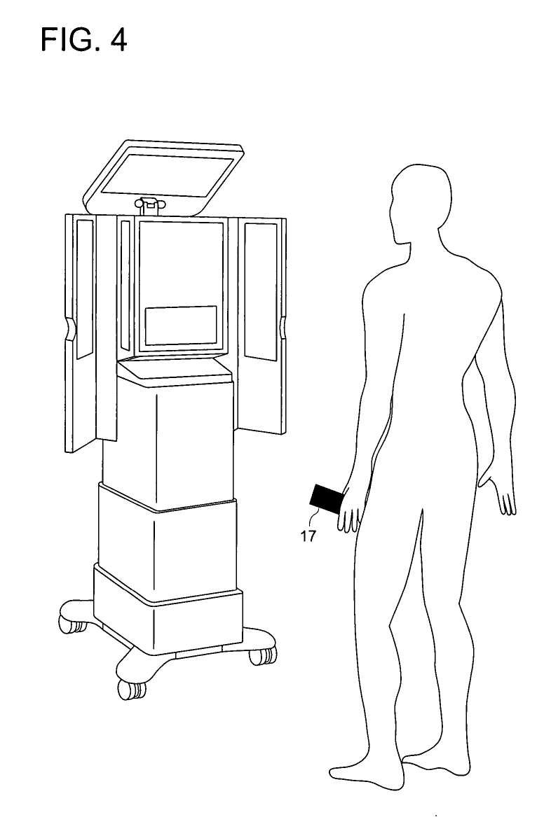

FIG. 4 shows a front view of an outer appearance of a portrait photography apparatus G when the photographing operation is activated.

The photographer usually operates the remote controller 17 to adjust the height of the accommodating section 10 so that the height of eyes of the person serving as the subject is substantially the same as that of the lens 15 of the camera 13.

FIG. 4 shows a view of an outer appearance of the portrait photography apparatus G when the photographing operation is deactivated.

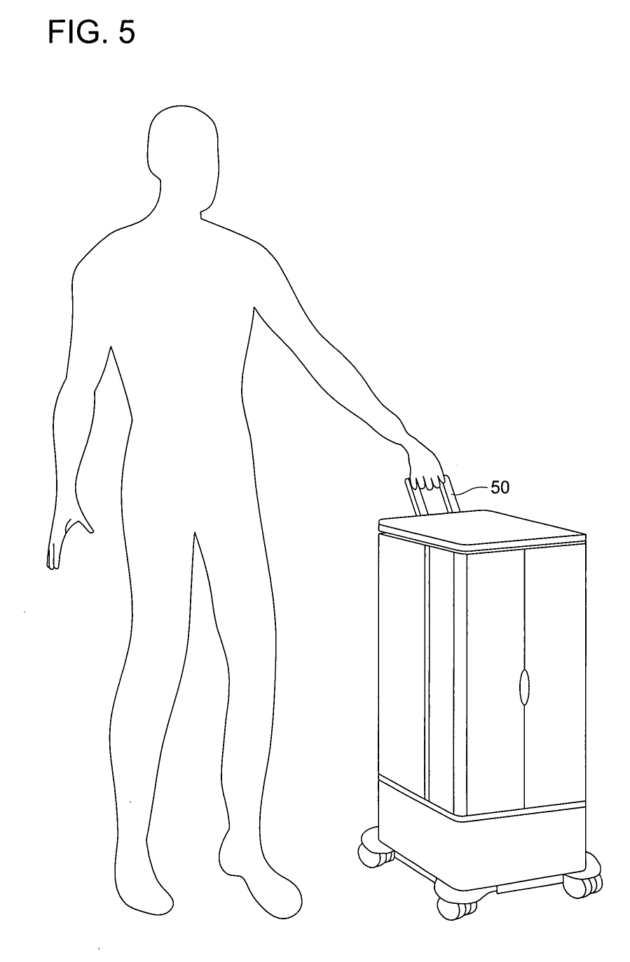

When the photographer completes the consecutive photographing operations, the photographer operates the remote controller 17 to set the height of the accommodating section 10 at the allowable lowest position, and to close the outer enclosure 19, which is currently opened. As shown in FIG. 5, since a carrying handle 50 is attached to the back surface of the accommodating section 10 of the portrait photography apparatus G, and since the portrait photography apparatus G is in such a state that its height is minimum and it is enclosed by the outer enclosure, it becomes possible for the user to easily move the portrait photography apparatus G.

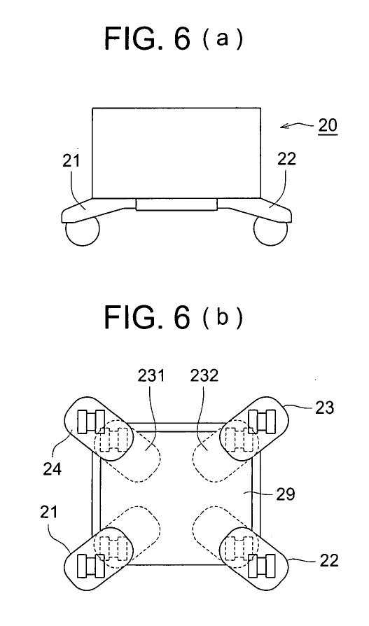

FIG. 6(a) and FIG. 6(b) show conceptual schematic diagrams indicating a configuration of the supporting section 20, and are a side view and a bottom view, respectively.

As shown in FIGS. 6(a)-6(b), the supporting section 20 is provided with four leg members 21, 22, 23, 24 attached to a bottom plate 29. A roller having a stopper is mounted onto the top portion of each of the four leg members 21, 22, 23, 24, which is slidable relative to the bottom plate 29.

Further, each of the four leg members 21, 22, 23, 24, which is slidably attached to the bottom plate 29, can be fixed at a position indicated by the solid line or another position indicated by the broken line. Concretely speaking, each of the four leg members 21, 22, 23, 24 can slide within a predetermined stroke range along a groove formed in advance at a predetermined position of the bottom plate 29, and each of the four leg members 21, 22, 23, 24 is fixed at the abovementioned position by making a pin, attached to each of them, insert downward into a hole provided in advance in the groove. This fixing method is a well-known method of general purpose.

During the operating time of the portrait photography apparatus G, each of the four leg members 21, 22, 23, 24 is fixed at the position indicated by the solid line so as to maintain the portrait photography apparatus G in a stable state in which the portrait photography apparatus G hardly turns over. On the other hand, during the non-operating time of the portrait photography apparatus G, in which the protrusions of the four leg members 21, 22, 23, 24 from the outer circumferential surface of the portrait photography apparatus G become cumbersome, or during the moving time of the portrait photography apparatus G, each of the four leg members 21, 22, 23, 24 is slid and fixed at the position indicated by the broken line.

The leg members 23, 24 are disposed at the side to which the carrying handle 50 shown in FIG. 5 is attached, and can be fixed at the positions indicated by the solid lines or positions 231, 232 indicated by the broken lines. Since the leg members 23, 24 are provided in such the manner mentioned in the above, by fixing the leg members 23, 24 at the positions indicated by the solid lines, and by fixing the leg members 21, 22 at the inner positions indicated by the broken lines, it becomes possible to move the portrait photography apparatus G while inclining it towards the carrying handle 50 side. This makes the work of moving the portrait photography apparatus G easier than ever.

What is claimed is:

1-4. (canceled)

5. A portrait photography apparatus, comprising:
an accommodating section that accommodates a camera and an illumination section, and includes an outer covering, which can be opened and closed, and which is disposed at an upper surface section or a side surface section;
a supporting section, disposed below the accommodating section, to support the accommodating section;
a height adjusting section, which is expandable and contractable, to connect the accommodating section to the supporting section; and
a plurality of leg members, each of which has a caster roller.

6. The portrait photography apparatus of claim 5, further comprising:
a control section to control the height adjusting section so that a height of the accommodating section during a non-operating time is lower than that during an operating time.

7. The portrait photography apparatus of claim 5,
wherein the accommodating section is provided with a carrying handle.

8. The portrait photography apparatus of claim 5,
wherein each of the plurality of leg members is movable inward and outward in respect to an outer circumferential surface of the supporting section, and at least two of the plurality of leg members can be maintained outward in parallel to each other, while another one of the plurality of leg members or other ones of the plurality of leg members can be maintained inward.
